(19) United States
(12) Patent Application Publication
(10) Pub. No.: US 2007/0029518 A1
(43) Pub. Date: Feb. 8, 2007

(54) Process for producing extinguishing agent

(76) Inventor: Shigeaki Hatakeyama, Tokyo (JP)

Correspondence Address: Berenato, White & Stavish, Ste. 240, 6550 Rock Spring Drive, Bethesda, MD, 20817, US

(21) Appl. No.: 11/198,321

(22) Filed: Aug. 8, 2005

(51) Int. Cl. A62D 1/00

(52) U.S. Cl. 252/2

(57) ABSTRACT

A process for producing an extinguishing agent comprises a step of incorporating sodium chloride in an amount of 5 to 15 g relative to 500 ml of water into hot water at a temperature of 30 to 40 degree C. to solve sodium chloride into the hot water, and a step of incorporating sodium hydrogen carbonate in an amount of 50 to 70 g relative to 500 ml of water into the solution. The resulting extinguishing having being incorporated in thus produced is incorporated in a container can be used for a fire extinguisher which is thrown at the origin of a fire when fire occurs. A safety extinguishing agent having no or little influence upon human body can be provided.

### BACKGROUND OF THE INVENTION

1. Field of the Invention

The present invention relates to a process for producing an extinguishing agent for fire.

2. Description of Related Arts

An extinguishing agent is made up of various composition. For example, Japanese Patent Laid-Open Publication No. 2001-37901 discloses an extinguishing agent comprising urea, sodium chloride, sodium carbonic anhydride, ammonium sulfate and the like.

However, amongst processes for producing an extinguishing agent, many of them do not disclose the detail of production as know-how of venders. A process for producing a distinguishing agent will be disclosed herein.

In recent years, in addition to a floor type fire extinguisher, a throwing type fire extinguisher have been commercialized, which is thrown to the origin of a fire. Since it is sometimes difficult to use the floor type fire extinguisher in the course of the actual action of extinguishing a fire, a throwing type fire extinguisher, which can extinguish a fire only by throwing it at the origin of a fire, may be considered to have easiness and convince of application.

However, all of components making up the fire extinguishing agent are not necessarily safe, and there is a possibility to cause a problem when a child or an aged people drinks it by mistake.

Accordingly, there is a need for a process for producing a safe extinguishing agent, which has no or little adverse influence on human body.

Furthermore, there is a need for providing a process for producing a safe extinguishing agent, which effectively conducts a treatment so that components incorporated therein may exhibit their action, to thereby produce an extinguishing agent having a high fire-extinguishing performance.

### SUMMARY OF THE INVENTION

According to the present invention, there is provided a process for producing an extinguishing agent comprising

process for producing an extinguishing agent comprising

a step of incorporating sodium chloride in an amount of 5 to 15 g and ammonium dihydrogenphosphate in an amount of 50 to 70 g both relative to 500 ml of water into hot water at a temperature of 30 to 40 degree C. to solve them into the hot water, and a step of incorporating sodium hydrogen carbonate in an amount of 50 to 70 g relative to 500 ml of water into the solution to be dissolved therein.

The process of the invention may further comprises a step of incorporating a surfactant.

According to another aspect of the present invention, there is provided a process for producing an extinguishing agent comprising a step of incorporating sodium chloride in an amount of 5 to 15 g and ammonium dihydrogenphosphate in an amount of 50 to 70 g both relative to 500 ml of water into hot water at a temperature of 30 to 40 degree C. to solve them into the hot water,, a step of incorporating sodium hydrogen carbonate in an amount of 45 to 70 g relative to 500 ml of water into the solution to be dissolved therein, a step of incorporating urea in an amount of 20 to 40 g relative to 500 ml of water into the solution to be dissolved therein, and a step of incorporating ammonium sulfate in an amount of 35 to 55 g relative to 500 ml of water to be dissolved therein.

The process according to another of the invention may further comprises a step of incorporating a surfactant.

### DESCRIPTION OF THE PREFERRED EMBODIMENTS

### First Embodiment

First embodiment of the present invention will now be described.

First, 5 to 15 g, e.g., 10 g of sodium chloride is incorporated in an appropriate amount of water at a temperature ranging from 30 to 40 degree C., for example, approximately, 40 degree C., and then the mixture is stirred to dissolve sodium chloride into water. Sodium chloride is utilized as a catalyst.

Subsequently, 50 to 70 g, for example, 60 g of ammonium dihydrogenphosphate is incorporated and dissolved therein, and 50 to 70 g, for example, 60 g of ammonium hydrogen carbonate is incorporated to cause a reaction to be dissolved.

Ammonium dihydrogenphosphate and ammonium hydrogen carbonate are thermally decomposed into carbon dioxide gas (CO₂) and ammonia gas (NH₃) during the course of fire extinguishing through combustion. Carbon dioxide gas has a function of shielding the supply of oxygen to burning products and a function of neutralizing and suppressing oxidation of burning products. Ammonia gas, which possesses a neutralization function and a cooling function, prevents re-ignition of burning products to avoid spreading fire to circumferences.

Subsequently, an appropriate amount of boiling water is added to the solution.

Next, water is added to total amount of extinguishing agent to be 500 ml.

Finally, as occasion may demand, effective amount , e.g., approximately 20 ml of a surfactant (e.g., alpha foam: surfactant for forming aqueous membrane foam, available from Yamato Protec K.K.) is added to 500 ml of the extinguishing agent.

Reactions brought about by combustion in the course of extinguishing fire are as follows:
(NH₄)₂HPO₃+NH₄HCO₃→PO₄+H₂O+4NH₃+CO₂
PO₄+H₂O+4NH₃+CO₂+CO(NH₂)₂→(2NH₃)₃PO₄+2CO+H₂
(2NH₃)₃PO₄+(NH₄)₂SO₄+2CO₂+H₂

The extinguishing agent thus produced is incorporated into a container to be ready for use. The container in which the extinguishing agent of the present invention is incorporated may be various kind of containers which can store the extinguishing agent of the present invention without deterioration of quality of the extinguishing agent of the present invention in a stable manner and which are not collided with the extinguishing agent of the present invention. Examples of the containers which can be used, include but are not restricted to metal-made containers, resin-made containers having a light weight.

### Second Embodiment

Next, a second embodiment of the present invention will be described.

First, 5 to 15 g, for example, 10 g of sodium chloride is incorporated in an appropriate amount of water at 30 degree C., and then the mixture is stirred to dissolve sodium chloride into water. Sodium chloride is utilized as a catalyst.

Subsequently, 50 to 70 g, for example, 50 g of ammonium dihydrogenphosphate is incorporated and dissolved therein, and 45 to 70 g, for example, 45 g of ammonium hydrogen carbonate is incorporated to cause a reaction to be dissolved.

Subsequently, boiling water is added to the resulting solution.

Ammonium dihydrogenphosphate and ammonium hydrogen carbonate are thermally decomposed into carbon dioxide gas and ammonia gas during the course of fire extinguishing through combustion. Carbon dioxide gas has function of shutting the supply of oxygen to burning products and neutralizing and suppressing oxidation of burning products. Ammonia gas, which possesses a neutralization function and a cooling function, prevents reignition of burning products to avoid spreading fire to circumferences.

Subsequently, 20 to 40 g, for example, 20 g of urea is incorporated and dissolved in the solution. Thereafter, 35 to 55 g, for example, 45 g of ammonium sulfate and an appropriate amount of boiling water are incorporated to dissolve ammonium sulfate.

Next, water is added to total amount of extinguishing agent to be 500 ml.

Urea is also thermally decomposed into carbon dioxide gas and ammonia gas by combustion in the course of extinguishing a fire. Due to a function of oxygen-shielding to the burning products possessed by carbon dioxide gas and functions of neutralization and cooling possessed by ammonia gas, burning products can be extinguished and spreading of fire to circumferences can be prevented.

Finally, as occasion may demand, 20 ml of a surfactant (e.g., alpha foam) is added to 500 ml of the extinguishing agent.

The extinguishing agent thus produced is incorporated in a container to be ready for use. The container in which the extinguishing agent of the present invention is incorporated may be various kind of containers which can store the extinguishing agent of the present invention without deterioration of quality of the extinguishing agent of the present invention in a stable manner and which are not collided with the extinguishing agent of the present invention. Examples of the containers which can be used, include but are not restricted to metal-made containers, resin-made containers having a light weight.

According to the first and second embodiments of the process for producing an extinguishing agent of the present invention, a safety extinguishing agent having no or little influence upon human body can be provided. The use of ammonium hydrogen sulfate increases extinguishing rate.

The extinguishing rate when the conventional ammonium carbonate is used and that when ammonium hydrogen carbonate is used are shown bellow.

TABLE 1

| | Rate |
|---|---|
| Ammonium carbonate | 45 seconds |
| Ammonium hydrogen carbonate | 25 seconds |

When being incorporated into an appropriate container, the extinguishing agent produced according to the present invention can be used for a fire extinguisher which is thrown at the origin of a fire when fire occurs. A safety extinguishing agent having no or little influence upon human body can be provided. The use of ammonium hydrogen sulfate increases extinguishing rate.

What is claimed is:

1. A process for producing an extinguishing agent comprising
a step of incorporating sodium chloride in an amount of 5 to 15 g and ammonium dihydrogenphosphate in an amount of 50 to 70 g both relative to 500 ml of water into hot water at a temperature of 30 to 40 degree C. to solve them into the hot water, and
a step of incorporating sodium hydrogen carbonate in an amount of 50 to 70 g relative to 500 ml of water into the solution to be dissolved therein.

2. The process according to claim 1, which further comprises a step of incorporating an effective amount of a surfactant.

3. The process according to claim 2, wherein said surfactant containing a fluorine-type surfactant for forming an aqueous membrane foam.

4. The process according to claim 1, wherein said extinguishing agent is incorporated in a container to be ready for use as a throwing type fire extinguisher.

5. The process according to claim 1, wherein after all of the components are dissolved in hot water, water is added to the final volume.

6. A process for producing an extinguishing agent comprising
a step of incorporating sodium chloride in an amount of 5 to 15 g and ammonium dihydrogenphosphate in an amount of 50 to 70 g both relative to 500 ml of water into hot water at a temperature of 30 to 40 degree C. to solve them into the hot water,
a step of incorporating sodium hydrogen carbonate in an amount of 45 to 70 g relative to 500 ml of water into the solution to be dissolved therein,
a step of incorporating urea in an amount of 20 to 40 g relative to 500 ml of water into the solution to be dissolved therein, and
a step of incorporating ammonium sulfate in an amount of 35 to 55 g relative to 500 ml of water to be dissolved therein.

7. The process according to claim 6, which further comprises a step of incorporating a surfactant.

8. The process according to claim 7, wherein said surfactant containing a fluorine-type surfactant for forming an aqueous membrane foam.

9. The process according to claim 6, wherein said extinguishing agent is incorporated in a container to be ready for use as a throwing type fire extinguisher.

10. The process according to claim 7, wherein an appropriate amount of boiling water is added to the solution, before urea is incorporated in the solution.
